(19) United States
(12) Patent Application Publication
(10) Pub. No.: US 2019/0371049 A1
(43) Pub. Date: Dec. 5, 2019

(54) TRANSFORM-BASED SHADOWING OF OBJECT SETS

(71) Applicant: Microsoft Technology Licensing, LLC, Redmond, WA (US)

(72) Inventors: Anthony Tunjen HSIEH, Kirkland, WA (US); Ryan Terry BICKEL, Kirkland, WA (US); Nick Alexander EUBANKS, Seattle, WA (US); Minmin GONG, Kirkland, WA (US); Danielle Renee NEUBERGER, Redmond, WA (US); Christopher Nathaniel RAUBACHER, Redmond, WA (US); Geoffrey Tyler TROUSDALE, Seattle, WA (US)

(21) Appl. No.: 15/994,989

(22) Filed: May 31, 2018

(51) Int. Cl. G06T 15/60

(52) U.S. Cl. CPC G06T 15/60

(57) ABSTRACT

Scenes of objects, such as models in three-dimensional environments and user interface elements in window-based computing environments, are often rendered with shadows cast by a first object on a second object based on a light source. Full graphics engines often produce rich and high-fidelity shadows but involve extensive computation that may be unsuitable for some lower-powered devices. Simple shadowing techniques, such as drop shadows, may be rendered with modest computational processing, but only within significant restrictions and with poor fidelity. Presented herein is a shadow rendering technique that involves identifying a silhouette cast by an object due to a light source and applying a geometric transform, based upon the positions of the objects and the light source within the scene. The shadows may further include variations for opacity and/or edge blurring, reflecting distances between the light source and the objects, and colored shadows that exhibit translucency as a stained-glass effect.

### BACKGROUND

Within the field of computing, many scenarios involve a presentation of an object set as a scene, such as a graphical presentation of a set of controls comprising a user interface of an application; a presentation of a set of regions, such as windows, comprising the visual output of a set of applications in a computing environment; and an arrangement of objects in a three-dimensional space as a media or gaming experience.

In such scenarios, the objects are often arranged in a space that features a simulated light source that causes objects to cast shadows on other objects. Many techniques may be utilized to calculate and generate such shadows, and the techniques may vary in some visual respects, such as geometric complexity among the objects of the scene; accuracy with respect to the shapes of the objects and the resulting shapes of the shadows cast thereby; adaptability to various types and colors of the light source; and suitability for more complex shadows, such as an object casting a shadow across a plurality of more distant objects. More sophisticated techniques may be devised that produce more realistic or aesthetically appealing shadows at the cost of computational complexity, which may not be suitable for lower-capacity computational devices, or which may not be compatible with other considerations such as maintaining high framerates. Conversely, less sophisticated techniques, such as simple drop shadows, may be devised that produce simple shadows in a computationally conservative manner, but that impose constraints on the geometric complexity of the scene and/or produce visual defects.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Presented herein are techniques for rendering scenes of objects that provide shadows that are more visually robust than simple drop-shadow techniques, yet significantly less computationally intensive than full-range shadows such as produced by raytracing. When the content of an object is rendered, the position of a light source relative to the object may create a silhouette that may be cast upon a plane within the scene. Such determinations may be efficiently calculated using geometric transforms to determine the shape and size of the silhouette based on a boundary of the object and the relative orientation of the object and the light source and/or the shape and size of the portion of the silhouette that is cast upon the plane.

In an embodiment, a device presents a scene comprising a set of objects, where the device comprises a processor and a memory storing instructions that, when executed by the processor, cause the device to render shadows using the techniques presented herein. Execution of the instructions causes the device to render content of a selected object; identify, within the scene, a position of the selected object, a plane, and a light source; determine a silhouette of the selected object that is cast by the light source; and apply a transform to the silhouette to generate a shadow according to a position of the object relative to the light source. Execution of the instructions further causes the device to render, into the scene, at least a portion of the shadow onto the plane; and present the scene including the content of the respective objects and the shadow rendered upon the plane.

In an embodiment, a method of presenting a scene comprising a set of objects involves an execution of instructions on a processor of a device. Execution of the instructions causes the device to render content of respective objects of the set; identify positions within the scene of a light source, a selected object, and a plane; determine a silhouette of the selected object created by the light source; and apply a transform to the silhouette to generate a shadow cast on the plane by the light source according to the positions. Execution of the instructions further causes the device to render at least a portion of the shadow onto the plane and present the scene including the content of the respective objects and the shadow cast upon the plane.

In an embodiment, a method of presenting a scene comprising a set of objects involves an execution of instructions on a processor of a device. Execution of the instructions causes the device to render content of a first object of the set that is closer to a light source than a second object; determine, for the first object, a silhouette that is cast by the light source; and apply a transform of the silhouette to generate a shadow cast on the plane of the second object by the light source according to positions of the first object, the second object, and the light source within the scene. Execution of the instructions further causes the device to render content of the second object including at least a portion of the shadow cast onto a plane of the second object and present the scene including the content of the first object and the shadow cast onto the plane of the second object.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of a set of example scenes that are produced by rendering various types of object sets that includes shadows cast by a light source.

FIG. 2 is an illustration of an example scenario featuring a rendering of a scene of objects that includes shadows cast by the objects in accordance with the techniques presented herein.

FIG. 3 is a component block diagram illustrating an example device featuring an example system for rendering a scene of objects that includes shadows cast by the objects in accordance with the techniques presented herein.

FIG. 4 is a flow diagram illustrating a first example method of rendering a scene of objects that includes shadows cast by the objects in accordance with the techniques presented herein.

FIG. 5 is a flow diagram illustrating a second example method of rendering a scene of objects that includes shadows cast by a first object of the scene on a second object of the scene in accordance with the techniques presented herein.

FIG. 6 is an illustration of an example computer-readable medium storing instructions that provide an embodiment of the techniques presented herein.

FIG. 7 is an illustration of an example scenario featuring some variations in the rendering of shadows in a scene of objects in accordance with the techniques presented herein.

FIG. 8 is an illustration of an example scenario featuring the inclusion of translucency in the rendering of shadows in a scene of objects in accordance with the techniques presented herein.

FIG. 9 is an illustration of an example scenario featuring the inclusion of clipping in the rendering of shadows in a scene of objects in accordance with the techniques presented herein.

FIG. 10 is an illustration of an example scenario featuring the rendering of a shadow on a curved plane in accordance with the techniques presented herein.

FIG. 11 is an illustration of an example computing environment in which at least a portion of the techniques may be utilized.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

### A. Introduction

Scenes of objects often involve rendering techniques that include the rendering of shadows cast by a first object on a second object due to a light source. Such rendering techniques may occur in a variety of scenarios to render a variety of object sets and may be applied on a variety of devices ranging from high-performance servers and workstations and gaming consoles to mobile devices such as phones and tablets. Many techniques may be devised for rendering the shadows into the scene that may be suitable for particular contexts, but unsuitable or even unusable in different scenarios.

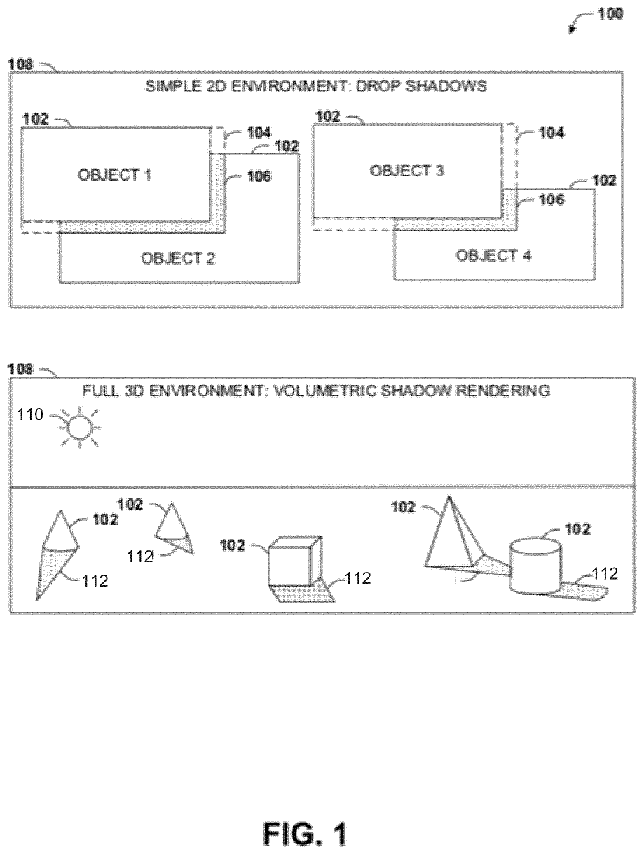

FIG. 1 is an illustration of a set 100 of example scenarios in which shadows may be rendered by a set of objects 102 into the scene. A first scenario 108 involves an object set that presents a comparatively simple two-dimensional environment as a collection of rectangles, such as rectangular windows in a window-based computing environment that respectively present the user interface of an application. Another example of such a scene involves an arrangement of rectangular user interface elements as the user interface of an application, such as buttons, textboxes, and rectangular images.

In such environments, the objects 102 may be arranged in a manner that causes a partial overlap of a first object 102 by a second object 102, such as a button that is positioned on top of an image. Alternatively or additionally, some computing environments may present a non-overlapping arrangement of objects 102, but may permit a rearrangement of the objects 102, such as relocation or resizing, that causes some objects 102 to overlap other objects 102. The overlapping may be achieved by storing a depth order of the objects 102, sometimes referred to as a z-order relative to a z-axis that is orthogonal to the display plane, and rendering the objects 102 in a particular order (such as a back-to-front order). However, the visual appearance of the overlapping objects 102 may be confusing to the user, e.g., if the boundaries of the objects do not clearly indicate whether an overlapping portion belongs to a first object or a second object. It may therefore be advantageous to supplement the rendered scene by including a visual representation of the depth, and a familiar visual representation for such depth includes the use of shadows. It may further be advantageous to produce such shadows in a computationally simple and efficient manner, e.g., without involving an excessive amount of calculation that diverts computational capacity away from the presented applications.

As further shown in the first example scenario 108, the depth relationships of the objects 102 may be represented using drop shadows 106, based on a simulated light source at a selected position (e.g., if the scene is a downward-facing view of the scene from a perspective, the light source may be selected at a position that is above the perspective and slightly offset upward and leftward). When a first object 102 is rendered, a boundary of the first object 102 may be adjusted by a fixed offset 104, such as a fixed number of pixels to the right and below the boundary of the object. When a second object 102 is rendered that is within the offset 104 of the first object 102, the intersecting portion of the second object 102 that is within the offset 104 of the first object 102 may be darkened to simulate a drop shadow 106 cast by the first object 102 on the second object 102.

Drop shadows 106 rendered such as depicted in the example scenario 108 of FIG. 1 provide a relatively simple technique that is computationally conservative (e.g., involving little more than the calculation of the fixed-size offset 104 of the boundary of the first object 102, the intersecting portion of the second object 102, and the darkening of the pixels within the intersecting portion). The relatively simple calculation involved in the rendering of drop shadows 106 may reserve the computational power of the device for processing the content of the applications, and/or may be applied on devices with comparatively modest processors, such as mobile phones and tablets, without significantly impacting the other processing tasks of the device.

However, the comparatively simple presentation of drop shadows 106 as presented in the example scenario 108 of FIG. 1 may exhibit a number of disadvantages. As a first example, the objects 102 may be restricted to polygonal planes that are all parallel to one another and orthogonal to the z-axis, because the simple calculations may not be adaptable to render drop shadows 106 between planes that are not parallel. In some such scenarios, the objects 102 may be further confined to rectangles, because calculating the offsets 104 and overlapping intersection of non-rectangular polygonal objects may increase the computational complexity. As a second example, the light source may have to be confined to a fixed location that is substantially directly above the object set, or at least within a small range of such a location, in which the shape of the drop shadow 106 is identical to the boundary of the object 102 casting the drop shadow 106. Shifting the light source to a significant incident angle may require the drop shadows 106 to be geometrically skewed, and the comparatively simple drop shadow techniques may not be easily adapted to produce this effect. As a third such example, the drop shadows 106 may be less capable at producing a visual effect of multiple layers of objects 102; e.g., it may be difficult to adapt the drop shadow 106 for casting on several objects 102 that are at different lower positions in the z-order. That is, it may be effective to present a first drop shadow 106 cast by a first object 102 on a second object 102 that is lower in the z-order, and a second drop shadow 106 cast by the second object 102 on a third object 102 that is even lower in the z-order. However, if the first object overlaps both the second object 102 and the third object 102, it may be difficult to adapt the drop shadow 106 to reflect the relative depth relationships of the second object 102 and the third object 102 (e.g., that the third object 102 is even further below the first object 102 than the second object 102). In this manner, the presentation of drop shadows 106 may exhibit visual defects that reveal the comparative simplicity of the calculations, and that reduce the aesthetic appearances of the shadows 106. In some cases, the visual defects may significantly diminish the aesthetic appeal of the rendered scene; e.g., rich images and carefully selected graphics techniques may present a conspicuous mismatch when accented by simplistic drop shadows. As a fourth such example, it may be difficult to achieve the rendering in first example scenario 108 with some rendering processes, wherein the drop shadow 106 is rendered concurrently with the object 102 casting the drop shadow 106, e.g., in a back-to-front manner, because the rendering of the drop shadow 106 may not be informed of other objects 102 beneath the object 102 casting the drop shadow 106. Rather, the drop shadow 106 may be rendered naively, e.g., as a darkening of graphics within the offset 104 of the object 102, and not particular to the actual presence or absence of objects 102 or portions thereof within the offset 104.

In a second example scenario 108, a full three-dimensional scene may be rendered as a set of volumetric objects 102, such as three-dimensional polygons of different shapes, sizes, colors, textures, positions, and orientations within a three-dimensional space. The rendering may involve a variety of techniques and calculations that render the volumetric objects 102 with various properties, including volumetric shadows 112 that are created by a light source 110. The volumetric shadows 112 are properly mapped onto other volumetric objects 102 within the scene, as well as portions of the background such as a representation of planes representing the ground, floor, walls, and/or ceiling of the scene. The rendering of volumetric shadows 112 may be achieved through techniques such as raytracing, involving a mapping of the path of each linear projection of light emanating from the light source 110 through the volumetric objects 102 of the scene to produce lit effects that closely match the appearance of such objects in a real-world scene. Other techniques that may be used to render volumetric shadows of the volumetric objects 102 in this three-dimensional space, including raycasting techniques that map rays emanating from the point of perspective through the scene of objects 102 and shadow-mapping techniques that test individual pixels of the display plane to determine the incidence of shadows.

The techniques depicted in the second example scenario may produce renderings of shadows that match the perspective within the scene; complex interactions and spatial arrangements of the volumetric objects 102; lighting types, such as specular vs. atmospheric lighting; and complex and sophisticated variety of volumetric objects, shape, and properties such as surface reflectiveness and texturing. However, the calculations involved in the implementation of these techniques may be very complicated and may consume a significant amount of computation. Many devices may provide plentiful computational capacity that is adequate for the implementation of complex shadowing techniques, including specialized hardware and software, such as graphics processing units (GPUs) with computational pathways that are specifically adapted for sophisticated shadow rendering techniques and graphics processing libraries that automate the rendering of shadows in a scene of volumetric objects. However, other devices may present limited computational capacity and may lack specialized graphics hardware and software support for shadowing. The application of such computationally intensive techniques may diminish the available computational capacity for other processing, including the substantive processing for an application for which a user interface is presented and in which shadowing is presented, resulting in delayed responsiveness of the user interface or the functionality exposed thereby. In some cases, complex shadowing techniques may be beyond the computational capacity of the device. In other scenarios, the aesthetic qualities of complex shadowing may be excessive compared with other qualities of the graphical presentation; e.g., complex volumetric shadows may look out of place when cast by simple and primitive graphics. In still other scenarios, the use of complex shadow rendering calculations may be significantly wasteful, such as complex rendering among primarily rectangular objects that results in simple, rectangular shadows that could be equivalently produced by simpler calculations.

These and other considerations may be reflected by the use of various shadowing techniques. For a particular object set, the use of a particular shadowing technique to render the scene may be overcomplicated or simplistic; may appear too sophisticated or too basic as compared with the content of the scene; may involve excessive computation that detracts from other computational processes; and may be inefficient, incompatible, or unachievable. It is therefore desirable to choose and provide new shadowing techniques that may be more suitable for selected rendering scenarios and object sets.

### B. Presented Techniques

Presented herein are techniques for rendering shadows in a manner that may be more robust than simple drop shadowing, and also less computationally intensive than full shadow-rendering techniques such as raytracing.

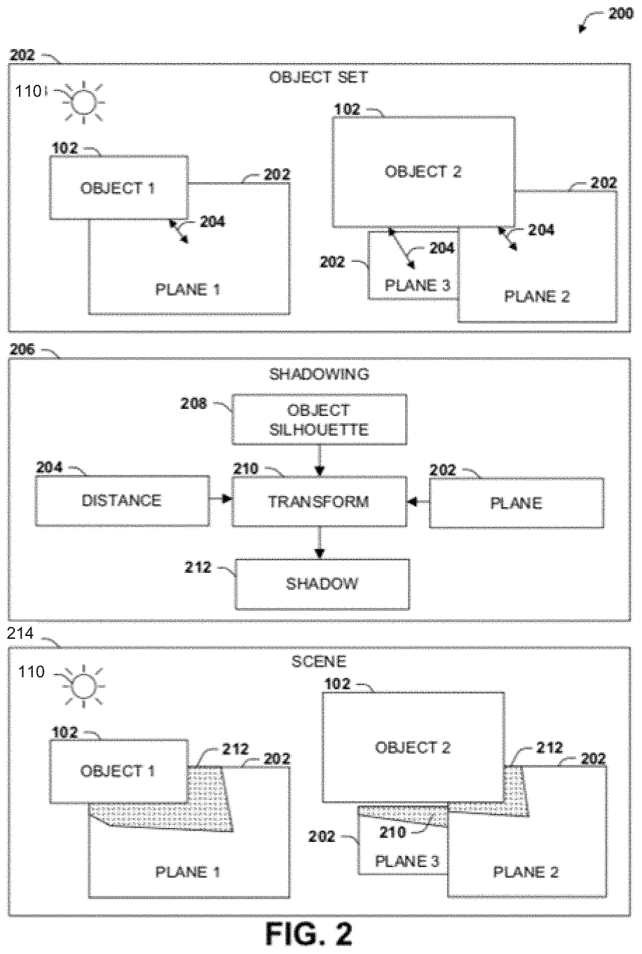

FIG. 2 is an illustration of an example scenario 200 featuring a rendering of objects in accordance with the techniques presented herein.

The example scenario 200 of FIG. 2 involves a set of objects that are presented in a scene comprising a light source 110. The objects 102 may comprise, e.g., two-dimensional objects such as planes that are positioned within a substantially two-dimensional environment and that respectively present content, such as windows or user controls, or three-dimensional objects that are arranged at various positions in a three-dimensional space. The positions of the objects 102 within the scene creates a depth aspect to the presentation; e.g., a substantially two-dimensional scene may include a depth aspect, such as a z-order that determines the order in which the objects 102 are rendered or the priority with which overlapping objects 102 are presented. The positions of the objects 102 within the scene are also rendered with shadows from a light source 110, such as a first object 102 that casts a first shadow onto a first plane 202 and a second object 102 that casts a shadow onto a second plane 202 and a third plane 202. In contrast with simpler techniques such as drop shadows 106, the shadows rendered in this example scenario 200 reflect the geometry of the scene, including the distance 204 between the respective objects 102 and the plane 202, such that the shadow cast upon the second and third planes 202, are rendered to reflect the different distances 204 with respect to the second object 102.

As further shown in the example scenario 200 of FIG. 2, shadows are rendered while rendering the object set by way of a shadowing technique 206. For a selected object 102, a silhouette 208 is identified, e.g., based on a border of the selected object 102 from the perspective of the light source 110. In contrast with the drop shadows 106 of FIG. 1, the light source 110 may be oriented relative to the selected object 102 with a significant incident angle from the z-axis, such that even if the object 102 is substantially rectangular, the silhouette 208 of the selected object 102 may present a non-rectangular quadrilateral. The silhouette 208 is subjected to a transform 210 based at least in part on a position of the selected object 102 from a plane 202. As a first example, the transform 210 may involve scaling the silhouette 208 inversely proportional with a distance 204 between the object 102 and the plane 202. As a second example, the transform 210 may involve adjusting a shape of the silhouette 208 if the object 102 and the plane 202 are not parallel, e.g., to reflect an incident angle of the shadow 212 upon the plane 202. The transform 210 may include other properties, such as a cropping of the shadow 212 to reflect the incident portion of the shadow 212 on the plane 202; an opacity of the shadow 212; a blurriness of the shadow 212, such as an edge blurring that reflects more diffuse shadowing that may occur as the distance between the light source 110 and the object 102 increases; and/or coloring that reflects a translucency of the content of the selected object 102 cast upon the plane 202. The shadow 212 produced by applying the transform 210 to the silhouette 208 of the object 102 may then be rendered on the plane 202, e.g., in combination with the content of the plane 202, such as darkening a portion of the surface of the plane 202 that is within the shadow 212.

As further shown in the example scenario 200 of FIG. 2, the scene 214 produced by the shadowing technique 206 may present shadows 212 that exhibit a number of properties. As a first example, the shadow 212 cast upon a plane 202 may properly reflect the spatial relationship of the light source 110, the objects 102, and the planes 202, including a transform of the silhouette 208 of the selected object 102 that may adapt the shape of the silhouette 208 to the incident angle between the object 102 and the plane 202. As a second example, the shadow 212 may span multiple planes 202 in a manner that is correctly clipped to each plane 202. As a third example, the shadow 212 spanning multiple planes 202 may convey not only a distance 204 between the object 102 and each plane 202 but also the distances between the planes 202 (e.g., visually indicating that the third plane 202 is positioned at a greater distance 204 with respect to the object 102 than the second plane 202). Such effects are not only achievable, but are achievable in a manner that is more computationally conservative and efficient than more complicated rendering techniques such as raytracing and shadow mapping, in accordance with the techniques presented herein.

### C. Technical Effects

The rendering of shadows 212 in the presentation of scenes of object sets in accordance with the techniques presented herein may provide one or several of the following technical effects.

As a first technical effect that may be achievable in accordance with the techniques presented herein, the rendering of a scene using the techniques presented herein may include shadows 212 that are more robust and aesthetically rich than many simple shadow rendering techniques, including the use of drop shadows 106 as depicted in the example scenario 108 of FIG. 1. For example, the shadows 212 rendered in accordance with the presented techniques may be more geometrically consistent with the positions of the object 102, the plane 202, and the light source 110 within the scene 214, e.g., by producing a silhouette 208 that is not identical to the size and shape of the boundary of the object 102 from the perspective of the scene 214, but that rather reflects an angle of incidence between the light source 110 and the object 102 with respect to the z-axis. As a result, in the example scenario 200 of FIG. 2, the shadow cast on the first plane 202 by the first object 102 is not merely an offset rectangle, but is a non-rectangular quadrilateral shape that conveys the spatial relationships of the light source 110, the first object 102, and the first plane 202. Additionally, the shadows 212 rendered in accordance with the presented techniques may also be capable of conveying more information than drop shadows; e.g., as shown in the example scenario 200 of FIG. 2, the shadow cast by the second object 102 upon the second plane 202 and the third plane 202 conveys not only that both planes 202 are behind the second object 102, but also the depth ordering between the second plane 202 and the third plane 202. If the depth ordering were reversed and the third plane 202 were closer to the object 102 than the second plane 202, a different shadow 212 would have been rendered across the planes 202 that conveyed this inverse relationship. Such distinctions may not be possible with simpler shadowing techniques such as drop shadows, where two objects 102 that are behind a first object 102 receive a similarly rendered drop shadow 106.

As a second technical effect that may be achievable in accordance with the techniques presented herein, the shadowing techniques presented herein may be easily extended to support a variety of additional features that otherwise may entail a significant increase in the computational cost of shadow rendering. As a first such example, relatively modest extensions of the shadow rendering techniques presented herein may add a variable opacity to shadows 212, which may be used, e.g., as a visual indicator of a directness of the light source toward the object 102 (such as distinguishing between a spotlight source and an ambient light source) and/or a distance 204 between the object 102 and the light source 110. As a second such example, relatively modest extensions of the shadow rendering may add a variable blurriness to the edges of shadows 212, which may be used, e.g., as a visual indicator of a distance 204 between the object 102 and the plane 202 upon which the shadow 212 is cast. As a third such example, relatively modest extensions of the shadow rendering may include some of the content of the object 102 in the shadow 212, such as tinting the shadow in accordance with the pictorial content of the object 102. Such tinting may promote the appearance of translucency of the object 102, e.g., as a stained-glass window effect. Whereas more sophisticated techniques like raytracing may entail a significant and perhaps large increase in computational complexity to achieve such features, the shadow rendering techniques presented herein may enable such features as merely an adjustment of the step in which the shadow 212 is rendered upon the plane 202.

As a third technical effect that may be achievable in accordance with the techniques presented herein, the shadowing techniques presented herein may involve simpler computational complexity than other rendering techniques, such as the volumetric shadowing technique shown in the example scenario 108 of FIG. 1. The conservation of computational processing may enable a device to utilize its computational capacity more fully to serve other tasks, such as semantic processing of the functionality exposed by a user interface that is rendered in accordance with the techniques presented herein, as well as other considerations, such as maintaining a high rendering framerate. Moreover, the conservation of computational processing may enable the use of relatively sophisticated shadowing on devices that may not be capable of utilizing more complex shadowing techniques such as volumetric shadows, such as mobile devices with comparatively limited processing capabilities and little or no specialized graphics rendering hardware or software. Many such potential advantages may be realized through the rendering of shadows 212 in accordance with the techniques presented herein.

### D. Example Embodiments

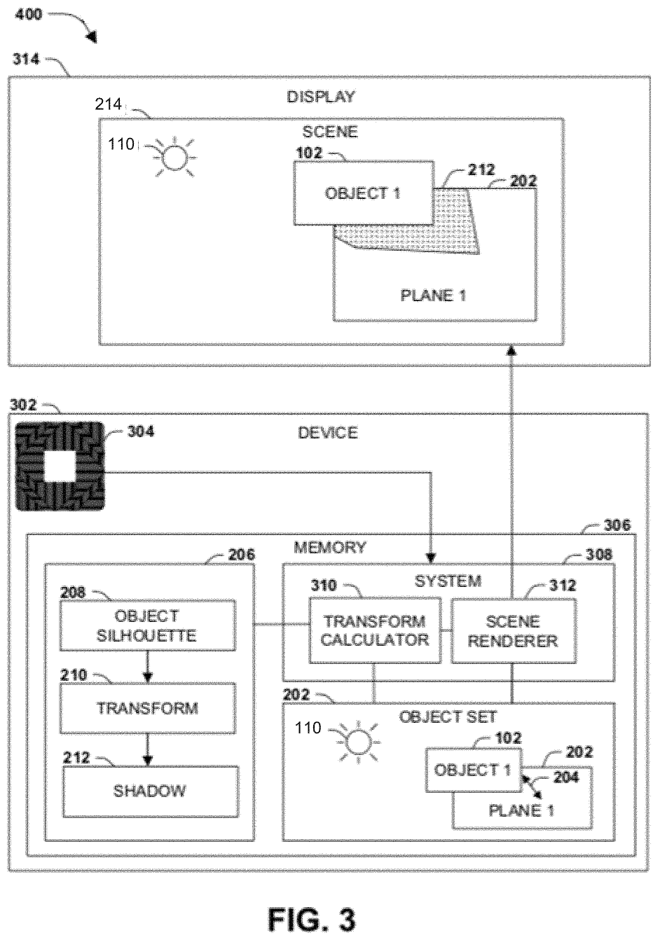

FIG. 3 is an illustration of an example scenario 300 featuring some example embodiments of the techniques presented herein, including an example device 302 that renders an object set of objects and an example system 308 that causes a device to render an object set of objects. The example device 302 comprises a processor 304 and a memory 306 (e.g., a memory circuit, a platter of a hard disk drive, a solid-state storage device, or a magnetic or optical disc) encoding instructions that, when executed by the processor 304 of the example device 302, cause the example device 302 to present a scene 214 including a shadow 212 cast upon a plane 202 by a selected object 102 in accordance with the techniques presented herein. It is to be appreciated that the scene 214 may comprise a plurality of objects 102 and planes 202, and may therefore render a number of shadows 212 thereupon, by repeating the shadowing technique between the selected object 102 and the plane 202 illustrated in the example scenario of FIG. 3.

The example system 308 renders the scene 214 of the objects 102 that includes, for a selected object 102, a shadow 212 cast onto a plane 202 in the following manner. The example system 308 comprises a transform calculator 310 that identifies, within the scene 214, a position of a selected object 102, a plane 202, and a light source 110; that determines a silhouette 208 of the selected object 102 that is cast by the light source 110; and that applies a transform 210 to the silhouette 208 to generate a shadow 212 to be cast upon the plane 202 according to the position of the object 102 relative to the light source 110 and the plane 202. The example system 308 further comprises a scene renderer 312, which rendering content of the selected object 102; renders, into the scene, at least a portion of the shadow 212 cast onto the plane 202 by the selected object 102; and presents the scene 214 including the content of the respective objects 102 and the shadow 212 rendered upon the plane 202. The scene 214 of the objects 102 may be presented, e.g., by a display 314 of the device 302, which may be physically coupled with the device 302 (e.g., an integrated display surface, such as a screen of a tablet, or a display connected by a cable, such as an external liquid-crystal display (LCD) display), or may be remote with respect to the device 302 (e.g., a display that is connected wirelessly to the device 302, or a display of a client device that is in communication with the device 302 over a network such as the internet). In this manner, the example device 302 enables the presentation of the scene 214 in accordance with the shadowing techniques presented herein.

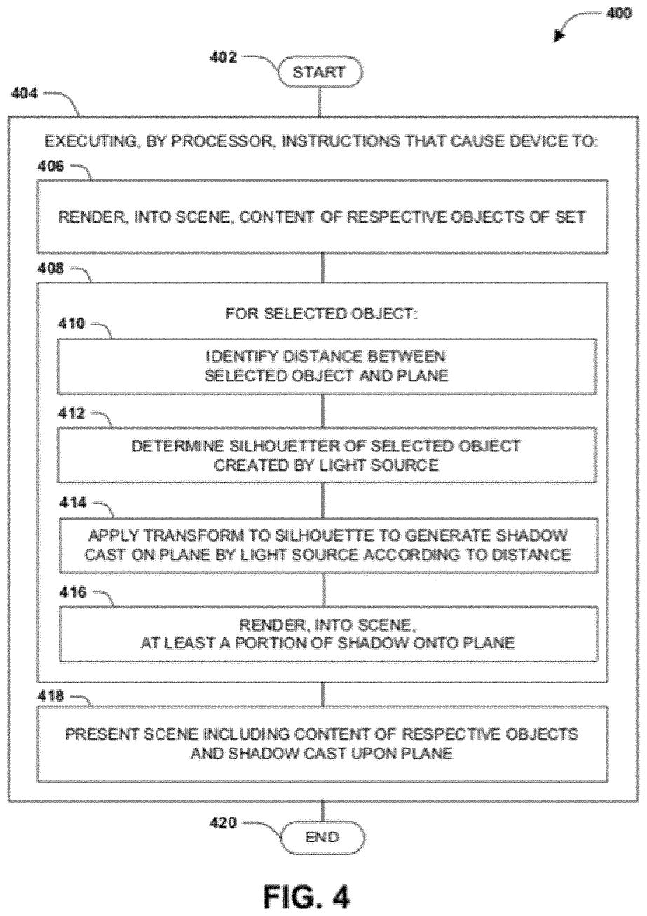

FIG. 4 is an illustration of an example scenario featuring a third example embodiment of the techniques presented herein, wherein the example embodiment comprises an example method 400 of rendering a scene of objects in accordance with techniques presented herein. The example method 400 involves a device comprising a processor 304, and may be implemented, e.g., as a set of instructions stored in a memory 306 of the device, such as firmware, system memory, a hard disk drive, a solid-state storage component, or a magnetic or optical medium, wherein the execution of the instructions by the processor 304 causes the device to operate in accordance with the techniques presented herein.

The first example method 400 begins at 402 and involves executing 404, by the device, instructions that cause the device to operate in the following manner. Execution of the instructions causes the device to render 406 the content of respective objects 102 of the object set. Execution of the instructions causes the device to identify 408 positions within the scene 214 of a light source 110, a selected object 102, and a plane 202. Execution of the instructions causes the device to determine 410 a silhouette 208 of the selected object 102 created by the light source 110. Execution of the instructions causes the device to apply 412 a transform 210 to the silhouette 208 to generate a shadow 212 cast on the plane 202 by the selected object 102 and the light source 110 according to the positions of the light source 110, the selected object 102, and the plane 202 within the scene 214. Execution of the instructions causes the device to render 414 at least a portion of the shadow 212 onto the plane 202. Execution of the instructions causes the device to present 416 the scene 214 including the content of the respective objects 102 and the shadow 212 cast upon the plane 202. Having achieved the presentation of the scene 214 in accordance with the shadowing techniques presented herein, the example method 400 ends at 418.

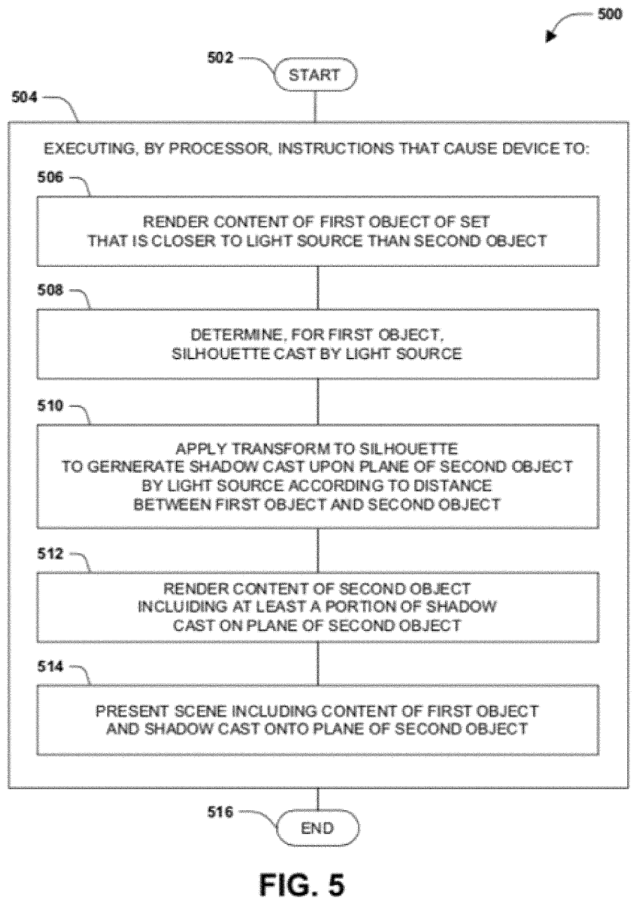

FIG. 5 is an illustration of an example scenario featuring a fourth example embodiment of the techniques presented herein, wherein the example embodiment comprises an example method 500 of rendering a scene of objects in accordance with techniques presented herein. The example method 500 involves a device that comprises a processor 304, and may be implemented, e.g., as a set of instructions stored in a memory 306 of the device, such as firmware, system memory, a hard disk drive, a solid-state storage component, or a magnetic or optical medium, wherein the execution of the instructions by the processor 304 causes the device to operate in accordance with the techniques presented herein.

The fourth example method 500 begins at 502 and involves executing 504, by the device, instructions that cause the device to operate in the following manner. Execution of the instructions causes the device to render 506 content of a first object of the set that is closer to a light source than a second object. Execution of the instructions further causes the device to determine 508, for the first object, a silhouette that is cast by the light source. Execution of the instructions further causes the device to apply 510 a transform of the silhouette to generate a shadow cast on the plane of the second object by the light source according to positions of the first object, the second object, and the light source within the scene. Execution of the instructions further causes the device to render 512 content of the second object including at least a portion of the shadow cast onto a plane of the second object. Execution of the instructions further causes the device to present 514 the scene including the content of the first object and the shadow cast onto the plane of the second object. Having achieved the presentation of the scene 214 in accordance with the shadowing techniques presented herein, the example method 500 ends at 516.

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

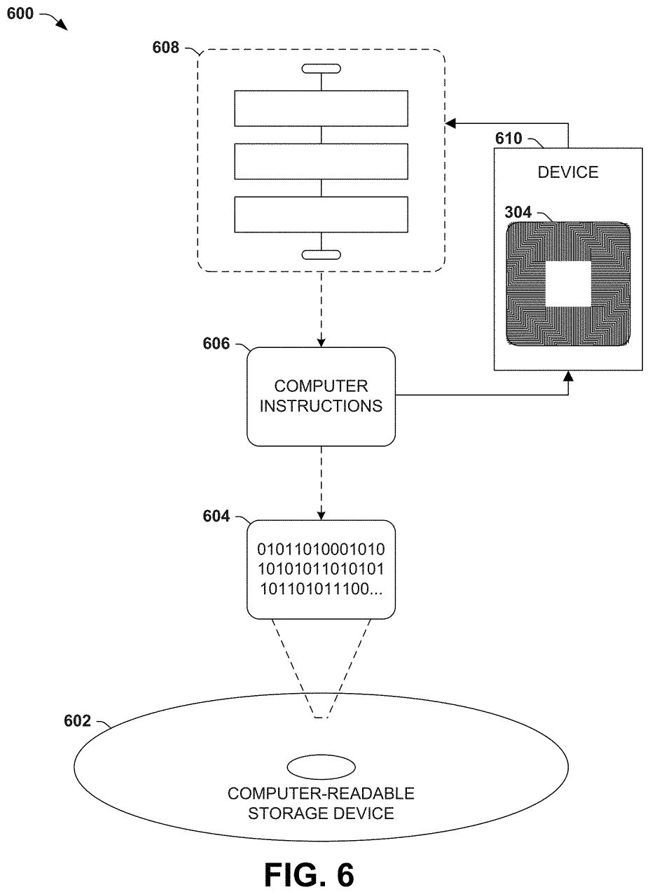

An example computer-readable medium that may be devised in these ways is illustrated in FIG. 6, wherein the implementation 600 comprises a computer-readable memory device 602 (e.g., a CD-R, DVD-R, or a platter of a hard disk drive), on which is encoded computer-readable data 604. This computer-readable data 604 in turn comprises a set of computer instructions 606 that, when executed on a processor 304 of a device 602, cause the device 602 to operate according to the principles set forth herein. For example, the processor-executable instructions 606 may encode a system that causes the device 602 to render a scene of objects, such as the example system 308 in the example scenario 300 of FIG. 3. As another example, the processor-executable instructions 606 may encode a method of rendering a scene of objects, such as the example method 400 of FIG. 4, or the example method 500 of FIG. 5. Many such computer-readable media may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example device 302 and/or example system 308 of FIG. 3; first example method of FIG. 4; the second example method of FIG. 5; and the example device 602 and/or example method 608 of FIG. 6) to confer individual and/or synergistic advantages upon such embodiments.

E1. Scenarios

A first aspect that may vary among implementations of these techniques relates to scenarios in which the presented techniques may be utilized.

As a second variation of this first aspect, the presented techniques may be utilized with a variety of device, such as workstations, laptops, consoles, tablets, phones, portable media and/or game players, embedded systems, appliances, vehicles, and wearable devices. The techniques may also be implemented on a collection of interoperating devices, such as a collection of processes executing on one or more devices; a personal group of interoperating devices of a user, such as a personal area network (PAN); a local collection of devices comprising a computing cluster; and/or a geographically distributed collection of devices that span a region, such as a remote server that renders a scene and transmits the result to a local device that displays the scene for a user. Such devices may be interconnected in a variety of ways, such as locally wired connections (e.g., a bus architecture such as Universal Serial Bus (USB) or a locally wired network such as Ethernet); locally wireless connections (e.g., Bluetooth connections or a WiFi network); remote wired connections (e.g., long-distance fiber optic connections comprising Internet); and/or remote wireless connections (e.g., cellular communication).

As a second variation of this first aspect, the presented techniques may be utilized a variety of scenes and object sets. For example, the respective objects may comprise user interface elements (e.g., buttons, textboxes, and lists) comprising the user interface of an application, and the scene may comprise a rendering of the user interface of the application. The respective objects may comprise the user interfaces of respective applications, and the scene may comprise a rendering of the computing environment. The respective objects may comprise media objects, and the scene may comprise an artistic depiction of the collection of media objects. The respective objects may comprise entities, and the scene may comprise the environment of the entities, such as a game or a simulation. As a second example, the scene may be rendered as a three-dimensional representation or as a two-dimensional representation with the use of shadows to simulate depth in a z-order. As a third example, the light source may comprise a narrowly focused directed beam of light, such as a spotlight, flashlight, or laser, or a broadly focused source of ambient lighting, such as the sun or an omnidirectional light bulb. As a fourth example, a plane 202 onto which a shadow is cast may comprise an element of another object 102 or a background element, such as the ground, floor, walls, or ceiling of the environment. The plane 202 may also be defined, e.g., as a mathematical description of a distinct region of a two- or three-dimensional space, such as a mathematical description of the plane 202; or as a set of coordinates that define a boundary of the plane 202; or as a set of parameters defining the boundaries of a two- or three-dimensional geometric shape; or as a selected surface portion of an object 102, such as a portion of a two- or three-dimensional model. As a fifth example, the plane may also be positioned, e.g., further from the object 102 casting the shadow 212, such that the shadow 212 is projected along the vector rooted at the object 102 and opposite the direction of the light source 110. Alternatively, in some scenarios, the plane 202 may be positioned within the scene 214 between the light source 110 and the object 102, and it may be desirable to render the shadow 102 on the plane 202, e.g., as a darkened portion of a translucent plane 202 through which the object 102 is partially visible. Many scenarios may be devised in which a scene is presented with shadows rendered in accordance with the techniques presented herein.

E2. Shadow Rendering Variations

A second aspect that may vary among embodiments of the techniques presented herein involves the computational process of rendering the shadows 212.

As a first variation of this second aspect, the transform 210 may comprise a variety of techniques and may be generated and used in a variety of ways. As a first such example, the transform 210 may be encoded in various ways. For example, the transform 210 may comprise a mathematical formula that is applied to a mathematical representation of the silhouette 208 of the object 102 to generate an altered mathematical representation of the shadow 212. Alternatively, the transform 210 may comprise a set of logical instructions that are applied to a data set representing the silhouette 208 to generate an updated data set representing the shadow 212. As another alternative, the silhouette 208 may comprise an image representation of a border of the object 102, and the transform 210 may comprise a filter that is applied to the silhouette 208 to produce an image representation of the shadow 212. As a second example, a device may store a transform 210 before receiving a request to render the scene 214, and shadows 212 may be rendered into a scene by retrieving the transform 210 stored before receiving the request to generate the shadow 212 from the silhouette 208. Storing the transform 210 prior to rendering the scene 214 may be advantageous, e.g., for scenes with comparatively static content that are anticipated to be rendered in the future, such as a scene that presents a subset of viewing perspectives that are respectively associated with a stored transform 210 to generate a shadow upon a particular plane 202, where retrieving the stored transform 210 further comprises retrieving the stored transform 210 that is associated with the viewing perspectives of the scene 214. Alternatively, the transform 210 may be stored after a first rendering of the scene including a first content of the selected object 102 (e.g., as part of a transform cache that may be reused a scene that is typically dynamic, but where the object 102, light source 110, and plane 202 are at least briefly static), and the rendering may involve applying the stored transform 210 to a second rendering of the scene 214 including a second content of the selected object.

As a second variation of this second aspect, the transform 210 may be applied at various stages of the rendering pipeline. As a first such example, a transform 210 may be applied to generate the silhouette 208, e.g., by comparing a basic representation of the object 102 (e.g., a rectangular depiction such as a window, or the three-dimensional model of the object 102) and the relative positions of the object 102 and the light source 110 to determine the silhouette 208 of the object 102, such as the boundary of the object 102 from the perspective of the light source 110. The silhouette 208 may be generated using a transform 210 as part of the process of generating the shadow 212 or as a separate discrete step, e.g., while rendering the content of the object 102. As a second such example, the determination of the incidence of shadow 212 cast by the object 102 upon the plane 202 (e.g., the determination of which paths between a light source 110 and a plane 202 are at least partially occluded by an object 102) may occur at various stages, including before the objects 102 and planes 202; while rendering the objects 102 and planes 202; and after rendering the objects 102 and planes 202. As a third such example, the shadow 212 for a particular plane 202 may be generated while rendering the object 102, and then stored until the rendering process begins to render the plane 202, at which point the plane 202 may be rendered together with its shadow 212. Alternatively, the shadow 212 of the object 102 may be determined to fall upon the plane 202 while rendering the plane 202, and the shadow 212 may be generated and promptly applied to the content of the plane 202. As another alternative, the objects 102 and planes 202 of the scene 214 may be rendered, and then shadows 212 may be determined from the light sources 110 and the previously rendered planes 202 may be updated with the shadow 212. That is, the step of determining which shadows 212 exist within the scene 214 may occur as part of the same step as rendering the content of the objects 102 and planes 202 or as a separate rendering step.

As a third variation of this second aspect, the rendering of shadows 212 in accordance with the techniques presented herein may give rise to a variety of shadow effects within a scene 214. As a first such example, a variety of additional aspects of rendering the shadows 212 on the planes 202 may be included at various stages of the rendering. For example, a second object 102 of the set may comprise a selected object shape that presents a first shadow shape using a first transform 210, and a different object 102 of the set that exhibits the same selected object shape may presents a second shadow shape using a second transform 210 (e.g., because the objects 102 have different positional and/or orientation relationships with respect to the light source 110). As a second such example, a selected object 102 may comprises a selected object shape, and the rendering may comprise rending a first shadow 212 of the selected object 102 onto a first plane 202 with a first shadow shape using a first transform 210, and rending a second shadow of the selected object 102 onto a second plane 202 with a second shadow shape that is different than the first shadow shape using a second transform 210 that is different than the first transform 210 (e.g., starting with the same silhouette 208 of the selected object 102, but rendering different shadows 212 with different shapes upon different planes 202 that have a different positional and/or orientation relationships with respect to the selected object 102). As a third such example, a selected object 102 may comprises a selected object shape, but rendering the shadows 212 created by the selected object 102 may comprise rending a first shadow 212 of the selected object 102 onto the plane 202 with a first shadow shape using a first transform 210 according to a first light source 110, and rending a second shadow 212 of the selected object 102 onto the plane 202 with a second shadow shape using a second transform 210 according to a second light source 110 that is different than the first light source 110 (e.g., casting two different shadows from the object 102 onto the plane 202 from two different light sources 110). Many such variations may arise in the rendering of shadows 212 in accordance with the techniques presented herein.

E3. Additional Shadowing Features

A third aspect that may vary among embodiments of the techniques presented herein involves the implementation of additional features that may be included in the rendering of shadows 212 in accordance with the techniques presented herein.

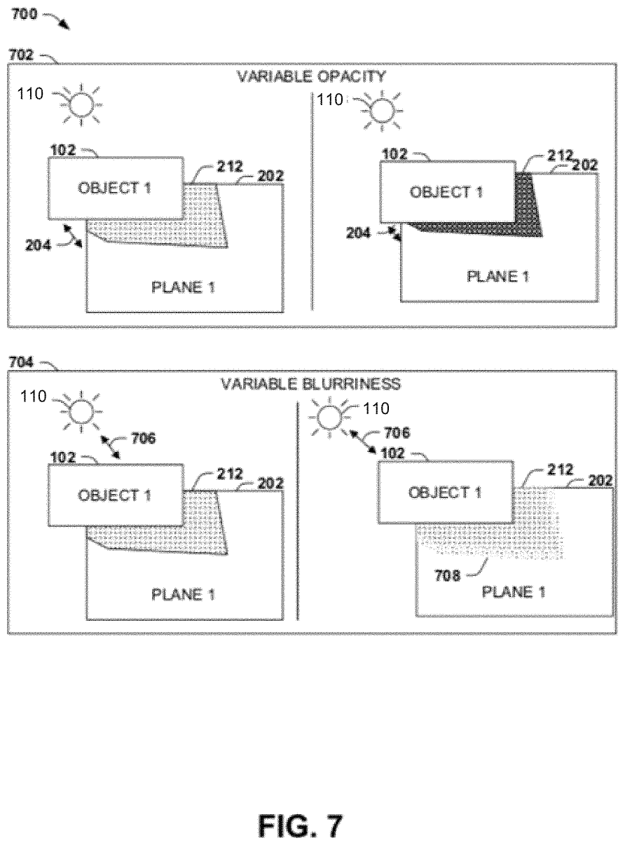

FIG. 7 is an illustration of a set of example scenarios 700 depicting two such features. FIG. 7 presents a first example scenario 702 depicting a first such feature, wherein the shadow 212 further comprises an opacity, and applying the transform further comprises adjusting the transform 210 of the silhouette 208 according to the opacity of the shadow 212. The opacity may comprise, e.g., a degree to which the shadow 212 darkens the content of the plane 202. In this example scenario 700, opacity is used to depict a distance 204 between the selected object 102 and the plane 202, where the opacity varies relative to the distance 204 between the plane 202 and the selected object 102. As another variation, the scene 214 may further comprise an ambient light level, and the transform 210 may be adjusted to vary the opacity according to the ambient light level (e.g., the shadow cast by a light source 110 may appear deeper if the ambient light level is low than if the ambient light level is high).

FIG. 7 also depicts a second example scenario 704 depicting a second such feature, wherein the shadow 212 further comprises a blurriness, and applying the transform further comprises adjusting the transform 210 of the silhouette 208 according to the blurriness of the shadow 212. In this example scenario 700, blurriness is used to depict a distance 204 between the selected object 102 and the light source 110, where the blurriness varies relative to the distance 204 between the selected object 102 and the light source 110. Alternatively, various light sources 110 may further comprise a light source type of the light source (e.g., a spotlight vs. omnidirectional light source), and rendering the shadow 212 may comprise varying an intensity of the shadow 212 relative to the light source type of the light source.

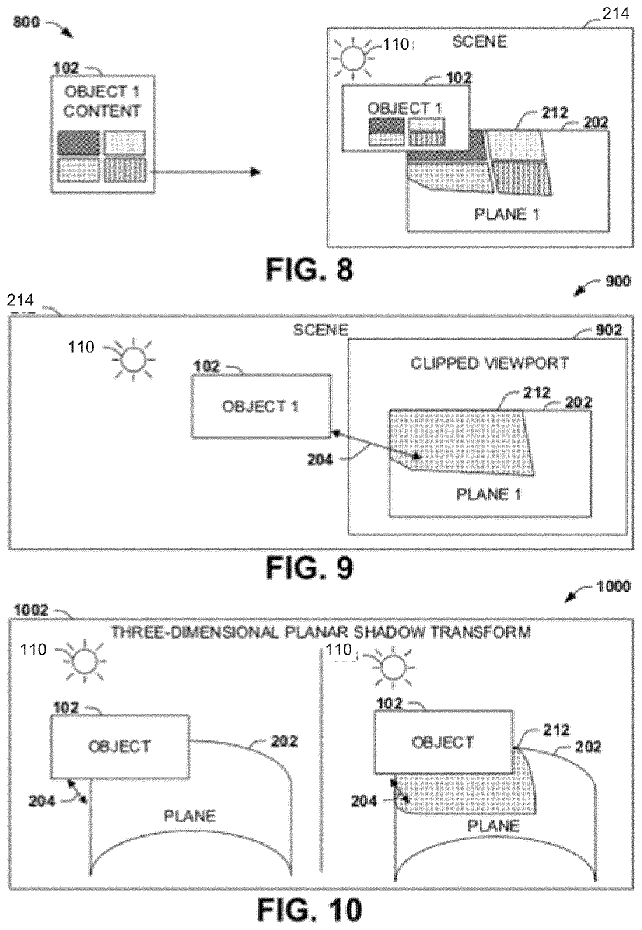

FIG. 8 is an illustration of an example scenario 800 depicting a third such feature, wherein the shadow 212 further comprises rendering the shadow 212 onto the plane 202 with an aspect of the content of the first object 102. In this example scenario 800, the first object 102 is at least partly translucent, where certain portions of the content of the first object 102 comprise a transparency level that is at least sometimes less than fully opaque. The shadow 212 that is rendered upon the plane 202 may vary according to the transparency levels of the respective portions of the content of the object 102. As an example, the transparency may comprise translucency, in which the content comprises one or more colors, and the shadow 212 may include portions that reflect the respective colors of the rendered content of the first object 102, thereby enabling a stained-glass effect.

FIG. 9 is an illustration of an example scenario 900 depicting a fourth such feature, wherein the first object 102 that casts the shadow 212 is outside of a clipping viewport of the scene 214. In this example scenario 900, the scene 214 is rendered only as a portion that is viewable through a clipped viewport 902, such as a window into the scene that restricts the viewing perspective, and the object 102 is outside of the clipped viewport 902 and is not visible while the plane 202 is within the clipped viewport 902 and is visible. Nevertheless, the positions of the object 102, the plane 202, and the light source 110 may produce a shadow 212 cast upon the plane 202 by the object 102, and the shadow 212 may be rendered upon the plane 202 even though the object 102 casting the shadow 212 is outside of the clipped viewport 902.

In some scenarios in which the currently presented techniques are applied, the planes 202 and objects 102 may be substantially coplanar, e.g., in a simple desktop environment in which the plane of each window is substantially parallel with every other window, and the shadows 212 are created as a function of z-order that is visually represented as depth. Additionally, in some scenarios in which the currently presented techniques are applied, the objects 102 may be substantially two-dimensional, e.g., representing two-dimensional planes with no depth. Additionally, in some scenarios in which the currently presented techniques are applied, the planes 202 and objects 102 may be substantially square, rectangular, or another polygonal shape that enables shadows 212 to be rendered in a consistent manner. Alternatively, the currently presented techniques may be applied in scenarios featuring objects 102 and planes 202 that are not coplanar and/or substantially the same shape and/or not two-dimensional, but may vary among objects 102 and planes 202, or may vary for an object 102 and/or plane 202 that changes shape, position, or orientation over time or in response to various events. The currently presented techniques may be readily adaptable to cover such alternative scenarios.

FIG. 10 is an illustration of an example scenario 1000 depicting a fifth such feature, wherein the plane 202 further comprises a three-dimensional plane 202 exhibiting a three-dimensional shape, with least a portion that is not oriented parallel with the first object 102. In this example scenario 1000, the plane 202 is a curved surface that bulges outward toward the object 102. The shadowing techniques presented herein are implemented in this scene by applying the transform 210 to the three-dimensional shape of the plane 202; e.g., after generating the shadow 212 that would appear on the plane 202 if it were flat and parallel with the object 102, an additional transform may be applied to conform the shadow 212 to the three-dimensional shape of the plane 202. Many such variations may be included in embodiments of the shadowing techniques presented herein.

### F. Computing Environment

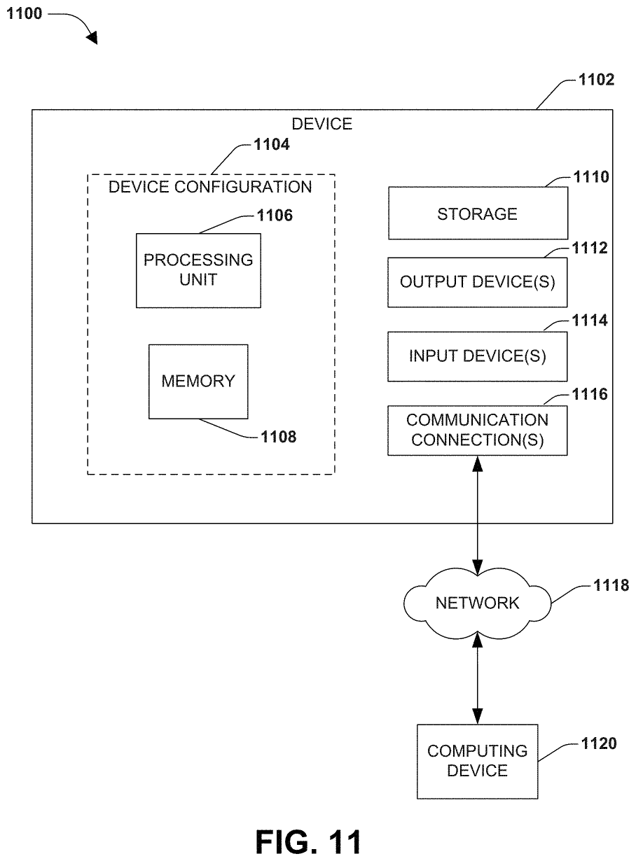

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system comprising a computing device 1102 configured to implement one or more embodiments provided herein. In one configuration, computing device 1102 includes at least one processing unit 1106 and memory 1108. Depending on the exact configuration and type of computing device, memory 1108 may be volatile (such as RAM, for example), non-volatile (such as ROM, flash memory, etc., for example) or some combination of the two. This configuration is illustrated in FIG. 11 by dashed line 1104.

In other embodiments, device 1102 may include additional features and/or functionality. For example, device 1102 may also include additional storage (e.g., removable and/or non-removable) including, but not limited to, magnetic storage, optical storage, and the like. Such additional storage is illustrated in FIG. 11 by storage 1110. In one embodiment, computer readable instructions to implement one or more embodiments provided herein may be in storage 1110. Storage 1110 may also store other computer readable instructions to implement an operating system, an application program, and the like. Computer readable instructions may be loaded in memory 1108 for execution by processing unit 1106, for example.

The term “computer readable media” as used herein includes computer storage media. Computer storage media includes volatile and nonvolatile, removable and non-removable media implemented in any method or technology for storage of information such as computer readable instructions or other data. Memory 1108 and storage 1110 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1102. Any such computer storage media may be part of device 1102.

Device 1102 may also include communication connection(s) 1116 that allows device 1102 to communicate with other devices. Communication connection(s) 1116 may include, but is not limited to, a modem, a Network Interface Card (NIC), an integrated network interface, a radio frequency transmitter/receiver, an infrared port, a USB connection, or other interfaces for connecting computing device 1102 to other computing devices. Communication connection(s) 1116 may include a wired connection or a wireless connection. Communication connection(s) 1116 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1102 may include input device(s) 1114 such as keyboard, mouse, pen, voice input device, touch input device, infrared cameras, video input devices, and/or any other input device. Output device(s) 1112 such as one or more displays, speakers, printers, and/or any other output device may also be included in device 1102. Input device(s) 1114 and output device(s) 1112 may be connected to device 1102 via a wired connection, wireless connection, or any combination thereof. In one embodiment, an input device or an output device from another computing device may be used as input device(s) 1114 or output device(s) 1112 for computing device 1102.

Components of computing device 1102 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 1102 may be interconnected by a network. For example, memory 1108 may be comprised of multiple physical memory units located in different physical locations interconnected by a network.

Those skilled in the art will realize that storage devices utilized to store computer readable instructions may be distributed across a network. For example, a computing device 1120 accessible via network 1118 may store computer readable instructions to implement one or more embodiments provided herein. Computing device 1102 may access computing device 1120 and download a part or all of the computer readable instructions for execution. Alternatively, computing device 1102 may download pieces of the computer readable instructions, as needed, or some instructions may be executed at computing device 1102 and some at computing device 1120.

### G. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. One or more components may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A device comprising:
a processor; and
a memory storing instructions that, when executed by the processor, cause the device to render shadows for respective objects by:
rendering content of a selected object;
identifying, within a scene comprising a set of objects, a position of the selected object, a plane, and a light source;
determining a silhouette of the selected object that is cast by the light source;
applying a transform to the silhouette to generate a shadow according to a position of the object relative to the light source;
rendering, into the scene, at least a portion of the shadow onto the plane; and
presenting the scene including the content of the respective objects and the shadow rendered upon the plane.

2. The device of claim 1, wherein:
the device stores the transform before receiving a request to render the scene; and
applying the transform further comprises: retrieving the transform stored before receiving the request to generate the shadow from the silhouette.

3. The device of claim 2, wherein:
the scene presents a subset of viewing perspectives that are respectively associated with a stored transform; and
retrieving the transform further comprises: retrieving the stored transform that is associated with the viewing perspectives of the scene.

4. The device of claim 2, wherein:
storing the transform further comprises: storing the transform after a first rendering of the scene including a first content of the selected object; and
retrieving the transform further comprises: applying the stored transform to a second rendering of the scene including a second content of the selected object.

5. The device of claim 2, wherein applying the transform further comprises: calculating the transform according to the content of the selected object, the light source, and the plane.

6. A method of presenting a scene comprising a set of objects, the method involving a device having a processor and comprising:
executing, by the processor, instructions that cause the device to:
render content of respective objects of the set;
identify positions within the scene of a light source, a selected object, and a plane;
determine a silhouette of the selected object created by the light source;
apply a transform to the silhouette to generate a shadow cast on the plane by the light source according to the positions;
render at least a portion of the shadow onto the plane; and
present the scene including the content of the respective objects and the shadow cast upon the plane.

7. The method of claim 6, wherein:
a second object of the set comprising a selected object shape presents a first shadow shape using a first transform; and
a first object of the set comprising the selected object shape presents a second shadow shape using a second transform.

8. The method of claim 6, wherein:
the selected object comprises a selected object shape; and
the rendering comprises:
rending a first shadow of the selected object onto a first plane with a first shadow shape using a first transform; and
rending a second shadow of the selected object onto a second plane with a second shadow shape that is different than the first shadow shape using a second transform that is different than the first transform.

9. The method of claim 6, wherein:
the selected object comprises a selected object shape; and
the rendering comprises:
rending a first shadow of the selected object onto the plane with a first shadow shape using a first transform according to a first light source; and
rending a second shadow of the selected object onto the plane with a second shadow shape using a second transform according to a second perspective that is different than the first perspective and a second light source that is different than the first light source.

10.-20. (canceled)

21. A computer readable storage medium storing instructions that, when executed by a processor of a computing device, cause the computing device to perform operations comprising:
rendering content of a selected object;
identifying, within a scene comprising a set of objects, a position of the selected object, a plane, and a light source;
determining a silhouette of the selected object that is cast by the light source;
applying a transform to the silhouette to generate a shadow according to a position of the object relative to the light source;
rendering, into the scene, at least a portion of the shadow onto the plane; and
presenting the scene including the content of the respective objects and the shadow rendered upon the plane.

22. The computer readable storage medium of claim 21, wherein:
the device stores the transform before receiving a request to render the scene; and
applying the transform further comprises: retrieving the transform stored before receiving the request to generate the shadow from the silhouette.

23. The computer readable storage medium of claim 22, wherein:
the scene presents a subset of viewing perspectives that are respectively associated with a stored transform; and
retrieving the transform further comprises: retrieving the stored transform that is associated with the viewing perspectives of the scene.

24. The computer readable storage medium of claim 22, wherein:
storing the transform further comprises: storing the transform after a first rendering of the scene including a first content of the selected object; and
retrieving the transform further comprises: applying the stored transform to a second rendering of the scene including a second content of the selected object.

25. The computer readable storage medium of claim 22, wherein applying the transform further comprises: calculating the transform according to the content of the selected object, the light source, and the plane.
